(19) United States
(12) Patent Application Publication
(10) Pub. No.: US 2009/0123350 A1
(43) Pub. Date: May 14, 2009

(54) Recovery of precious metals and their compounds from natural quartz ore using sodium silicate manufacturing techniques

(75) Inventor: Steven R. Sackett, Gulf Breeze, FL (US)

Correspondence Address: Steven R. Sackett, 1422 Little Duck Circle, Gulf Breeze, FL, 32563, US

(73) Assignee: Steven R. Sackett

(21) Appl. No.: 11/983,518

(22) Filed: Nov. 10, 2007

(51) Int. Cl. C01G 55/00; C01G 5/00; C01G 7/00; C22B 11/00

(52) U.S. Cl. 423/27; 423/22

(57) ABSTRACT

This patent is an improvement of the well known process outlined in U.S. Pat. No. 4,336,235. The current invention is unique in the fact that it applies this well-known manufacturing technique to the recovery of precious metals locked in natural quartz complexes. The desired products of the process described herein are the precious metals and their compounds, which are not recoverable in appreciable yields by standard mining recovery techniques from the natural quartz ore complexes. In the aforementioned patent the application as a viable mining recovery operation is not obvious, nor is the invention presented herein covered in the claims of the aforementioned patent. By applying the process described in the original patent to precious metals bearing quartz ore complexes, greater yields of precious metals than are currently attainable can result from the mining recovery operations

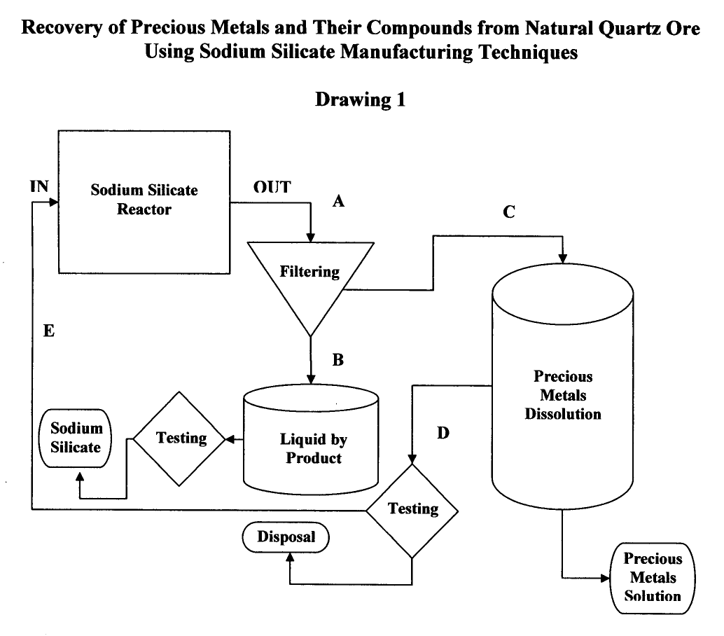

### BACKGROUND OF THE INVENTION

This invention extends the application of the original U.S. Pat. No. 4,336,235 to the recovery of precious metals and their compounds from natural quartz ore complexes found in mining operations. This application of the original manufacturing process is not obvious in the original patent. Using current mining recovery techniques, it notoriously difficult and inefficient to recover the precious metals and their compounds that are locked within these quartz complexes due to the encapsulation affect of the silicon dioxide (SiO.sub.2) matrix within the quartz. This invention uses a well-known manufacturing process to solve this recovery problem for mining operations. It will be assumed that when using the word ‘quartz’ herein the inventor is referring to the various crystalline structures of silicon dioxide (SiO.sub.2).

### SUMMARY OF THE INVENTION

The invention uses well-known manufacturing techniques to release encapsulated precious metals values from natural quartz ores in mining recovery operations. Standard mining recovery techniques used by current mining operations fail to recovery a large percentage of the encapsulated precious metals values. This invention can increase the yields from the current recovery levels to a much greater percentage.

### BRIEF DESCRIPTION OF THE DRAWING

Drawing 1 shows the functional flow diagram of the recovery stage of the precious metals mining operation using this technique. The block labeled ‘Sodium Silicate Reactor’ is detailed in the original referenced patent on the manufacture of Sodium Silicate from quartz. The ‘Precious Metals Dissolution’ block is any one of several well-known mining techniques capable of dissolving the precious metals values once they are free of the encapsulating quartz complexes.

### DETAILED DESCRIPTION

Using the same methods and equipment as described in U.S. Pat. No. 4,336,235 the granulated precious metals bearing quartz ore is fed into the sodium silicate reactor.

The output of the sodium silicate reactor at point A will be suspension of solid precious metals and their compounds as well as some solid natural quartz which have not been reacted. The liquid portion of this slurry will contain the sodium silicate and the water soluble compounds produced by the reactor.

The liquid portion is vacuum filtered off of the slurry at point B and contains the sodium silicate by product from the precious metals recovery process and is tested for precious metals then shipped off site for use in know applications of sodium silicate. If the tests on the liquid show positive results for dissolved precious metals the liquid is treated by well known mining techniques to recover the dissolved values.

The solids at point C from the filtering process are then treated by conventional refining techniques used in the mining industry to dissolve the concentrated precious metals and their compounds which have been released from the encapsulating natural quartz matrix.

The remaining solids from this dissolution reaction are sampled at point D. If the sample is examined and found to contain additional precious metals or compounds, the solids are added to the input slurry of the sodium silicate reactor for another cycle at point E. If the sample is depleted of values the waste solids are handled as is typical for the mining operation.

By means of this continuous process the quartz ore complex can be completely digested to recover all insoluble precious metals and precious metal compounds from the ore. The sodium silicate produced as a by product of the recovery of the precious metal compounds from the quartz ore can provide revenue for the mining facility to offset the costs of the additional processing step presented herein.

What is claimed:

1. The yields of precious metals and their compounds embedded in natural quartz ore complexes can be appreciably increased thru the application of sodium silicate manufacturing techniques to standard mining operations using the process described in this invention.

2. A primary by product of the mining recovery operations utilizing this invention for the recovery of precious metals and their compounds will be a marketable form of sodium silicate.
